(19) United States
(12) Patent Application Publication
(10) Pub. No.: US 2007/0085969 A1
(43) Pub. Date: Apr. 19, 2007

(54) Tri-extension combinable eyewear assembly

(76) Inventor: Greg Smith, Plano, TX (US)

Correspondence Address: STORM LLP, BANK OF AMERICA PLAZA, 901 MAIN STREET, SUITE 7100, DALLAS, TX, 75202, US

(21) Appl. No.: 11/501,469

(22) Filed: Aug. 9, 2006

Related U.S. Application Data
(63) Continuation-in-part of application No. 11/220,381, filed on Sep. 6, 2005, now abandoned.
Application No. 11/220,381 is a continuation of application No. 10/932,691, filed on Sep. 2, 2004, now Pat. No. 6,948,807.
(60) Provisional application No. 60/706,797, filed on Aug. 9, 2005.

(51) Int. Cl. G02C 9/00

(52) U.S. Cl. 351/47

(57) ABSTRACT

The improved assemblies disclosed herein employ auxiliary extensions that allow for either an interference fit or magnetic coupling to a primary frame, which is an improvement over more conventional designs. These auxiliary extensions provide a stable and aesthetically pleasing platform to couple an auxiliary lens assembly to a primary lens assembly. Additionally, the positioning of the auxiliary extensions allows for ease of use by requiring only a single hand while also providing increased resistance to decoupling when separating forces are applied. Thus, eyewear assembly provides a stable and useful primary and auxiliary lens assemblies that are both stable and easy to use, filling a long felt need in the industry.

### CLAIM OF PRIORITY

This application claims priority to U.S. Provisional Patent Application No. 60/706,797, entitled “TRI-EXTENSION COMBINABLE EYEWEAR ASSEMBLY” filed on Aug. 9, 2005 on behalf of Greg Smith, which is hereby incorporated by reference for all purposes. This application is a continuation-in-part of U.S. patent application Ser. No. 11/220,381, entitled “HORIZONTALLY COMBINABLE EYEWEAR ASSEMBLY” filed on Sep. 6, 2005, which is a continuation of U.S. Pat. No. 6,948,807, entitled “HORIZONTALLY COMBINABLE EYEWEAR ASSEMBLY,” filed on Sep. 4, 2004, on behalf of Greg Smith, which are hereby incorporated by reference for all purposes.

### TECHNICAL FIELD OF INVENTION

The present invention relates to eyewear, and in particular, to a combinable eyewear assembly that incorporating an auxiliary lens assembly for removable attachment to a primary lens assembly. Still more specifically, the present invention relates to an auxiliary lens assembly configured to engage the primary lens assembly in which three extensions engage each other between the primary and auxiliary assemblies when combined.

### BACKGROUND OF THE INVENTION

It has long been desirable to have a removable auxiliary lens assembly attached to eyeglasses. Professional baseball players have used “flip-up” auxiliary lenses for more than four decades to protect their eyes from the sun, but to allow them unrestricted vision in the event the ball was hit in their vicinity.

U.S. Pat. No. 6,053,611 to Ku (“Ku”) discloses an auxiliary lens assembly that magnetically couples to a primary lens assembly. Ku employs three different embodiments. In the first embodiment, magnetic coupling occurs between the auxiliary bridge and the primary bridge. In the second embodiment, magnetic coupling occurs at point above and below each of the primary extensions by auxiliary magnetic attachment assemblies. Finally, in the third embodiment, auxiliary magnetic attachment assemblies on the periphery couple to magnets in the primary frame.

U.S. Pat. No. 6,022,105 to Lin (“Lin”) is an auxiliary lens assembly that folds at the bridge. Accordingly, the auxiliary lens assembly mechanically couples to a primary lens assembly by fasteners above and below each of the primary extensions.

U.S. Pat. No. 6,375,321 to Lee et al. (“Lee”) discloses an auxiliary lens assembly that magnetically couples to a primary lens assembly. There are a multitude of configurations and locations of magnetic assemblies in and around the primary extension of the primary frame.

U.S. Pat. No. 6,811,254 to Ifergan (“Ifergan”) discloses an auxiliary lens assembly that magnetically couples to a primary lens assembly. Ifergan employs magnets strategically placed along the periphery of the auxiliary lens assembly or the primary lens assembly to enable the auxiliary lens assembly to “flip up” without the need or use of any permanent affixtures.

U.S. Pat. No. 6,412,942 to McKenna et al. (“McKenna”) discloses an auxiliary lens assembly that magnetically couples to a primary lens assembly. McKenna employs magnets strategically placed within the auxiliary frame or in a shelf extending from the auxiliary frame.

U.S. Pat. No. 6,742,889 to Fukwa (“Fukwa”) discloses an auxiliary lens assembly that magnetically couples to a primary lens assembly. Fukwa employs an L-shaped magnetic attachment assembly to couple to the primary extensions of the primary frame.

U.S. Pat. No. 6,775,522 to Strenk (“Strenk”) discloses an auxiliary lens assembly that couples to a primary lens assembly. Strenk employs mechanical couplings to secure the auxiliary frame, but is also equipped to utilize complementary magnetic attachment assemblies to secure the position of the auxiliary lens assembly.

U.S. Pat. No. 6,109,747 to Chao (“Chao”) is directed toward a hook that includes a magnet that operates as a magnetic attachment assembly for an auxiliary lens assembly, but the hook couples to a magnet on the rear side of the primary extension.

U.S. Pat. No. 5,980,036 to Solomon (“Solomon”) relates to an auxiliary lens assembly that either mechanically or magnetically couples to a primary lens assembly.

U.S. Pat. No. 6,354,703 to Sadler (“Sadler”) relates to clamps affixed to each of the auxiliary lens assembly and the primary lens assembly that allow the lens assemblies to magnetically couple to one another.

U.S. Pat. No. 6,164,774 to Cate (“Cate”) relates to a wire attachment assemblies on the auxiliary lens assembly that couple to posts on the primary lens assembly.

U.S. Pat. No. 6,113,234 to Huang (“Huang”) relates to an attachment assembly that allows the auxiliary lens assembly to mechanically couple to the primary lens assembly by way of a hook and recess.

U.S. Pat. No. 5,936,700 to Masunaga (“Masunaga”) relates to auxiliary lens assemblies coupling to a primary lens assemblies through mechanical and/or magnetic attachment assemblies.

U.S. Pat. No. 5,642,177 to Nishioka (“Nishioka”) relates to an auxiliary lens assembly employing a magnetic attachment assembly that couples to a magnetic attachment assembly on the face of the primary lens assembly.

German Patent No. 4316698 to Karp (“Karp”) relates to an auxiliary lens assembly employing a magnetic attachment assembly that couples to a magnetic attachment assembly on the face of the primary lens assembly.

Each of these conventional designs, however, lack the ability to provide a stable platform for which an auxiliary lens assembly can couple to a primary lens assembly. Specifically, these designs do not take advantage of supplying multiple contact points over a traditionally unstable axis. Moreover, these conventional designs also provide a limit number of aesthetically pleasing designs that appeal to a limited number of consumers.

It can thus be seen that there is a need to develop a design for a combined lens assembly which is attachable without the numerous extraneous parts and soldered assemblies of traditional designs, which encumber their appearance and limit the lens width, especially with frameless or rimless designs. There is also a need to provide a system capable of magnetic support in which the magnetic force is sufficient to support attachment of the auxiliary lens assembly to the primary lens assembly without the requirement of coextensively aligned mechanical engagement. There is also a need to simplify the structure and assembly of primary lens assemblies. There is also a need to provide a magnetically attached auxiliary lens assembly that is light-weight. There is also a need to provide an auxiliary lens assembly that is easily attachable to the primary frame assembly, without the need to maneuver extraneous component assemblies into engagement.

### SUMMARY OF THE INVENTION

It can be seen that the present invention provides a number of benefits over more conventional designs. Specifically, because the auxiliary extensions straddle the primary extensions, a wearer can easily couple the auxiliary lens assembly to the primary lens assembly with a single hand. Additionally, because the auxiliary extensions employ multiple coupling points, there is a decreased likelihood of decoupling when vertical and/or horizontal separating forces are applied. Moreover, there are a myriad of aesthetically pleasing designs that can be developed to have a greater appeal to wider variety of consumers.

An eyewear system is provided in accordance with a preferred embodiment of the present invention. A primary lens assembly comprising a primary frame for retaining a pair of primary lenses, a pair of primary extensions extending horizontally from the primary frame, and an arm pivotally attached to each of the primary extensions is provided. An auxiliary lens assembly comprising an auxiliary frame for retaining a pair of auxiliary lenses, a pair of upper extensions extending horizontally from each side of the auxiliary frame, and a pair of lower extensions extending horizontally from opposite sides of the auxiliary frame are also provided. The auxiliary frame is attachable to the primary frame by coincident alignment of the upper extensions above the primary extensions, and the lower extensions below the primary extensions.

In a preferred embodiment of the present invention, the distance between the primary extensions is greater than the distance between the upper extensions, and the distance between the primary extensions is greater than the distance between the lower extensions. In this description, the “distance between” is measured where extension is most proximate the primary frame.

In another preferred embodiment of the present invention, the upper extensions and the lower extensions engage the primary extensions in an interference fit.

In another preferred embodiment, each upper extensions is attached to a lower extension.

In yet another preferred embodiment of the present invention, the primary frame made of a magnetically attractable material. An upper magnet is located at an end of each upper extension, and a lower magnet is located at the end of each lower extension.

In another alternative embodiment of the present invention, an auxiliary lens assembly is provided. Accordingly, a first and a second auxiliary lens are employed. An auxiliary frame is utilized for securing the first and the second auxiliary lenses in a fixed relationship relative to one another. The auxiliary frame has a first axis extending from a periphery of said first auxiliary. lens to a periphery of said second auxiliary lens where a first attachment assembly and a second affixed along said periphery of said first auxiliary lens and straddling said first axis.

In yet another alternative embodiment of the present invention, the first magnetic attachment assembly further comprises a pair of micromagnets, wherein each micromagnet is substantially symmetrically positioned on either side of the first axis relative to one another.

In another preferred embodiment of the present invention, the auxiliary lens assembly further comprises a second axis that is orthogonal to said first axis, wherein said first and said second magnetic attachment assemblies are substantially symmetrically positioned on either side of said second axis relative to one another.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of an auxiliary lens assembly coupled to a primary lens assembly in accordance with a preferred embodiment of the present invention.

FIG. 2 is an isometric view illustrating the primary lens assembly of FIG. 1.

FIG. 3 is an isometric view illustrating the auxiliary lens assembly of FIG. 1.

FIG. 4 is a top view of auxiliary lens assembly attached to a primary lens assembly of FIG. 1.

FIG. 5 is a side view of auxiliary lens assembly attached to a primary lens assembly of FIG. 1.

FIG. 6 is a rear breakout view of the auxiliary lens assembly of FIG. 1.

FIG. 7 is a rear breakout view of an alternative embodiment of the auxiliary lens assembly of FIG. 1.

FIG. 8 is a rear breakout view of an alternative embodiment employing an interference fit of the auxiliary lens assembly.

FIG. 9 is a side view of auxiliary lens assembly attached to a primary lens assembly, where the auxiliary extension forms an “X.”

FIG. 10 is a rear breakout view of an alternative embodiment of the auxiliary lens assembly of FIG. 9.

### DETAILED DESCRIPTION OF THE PREFERRED EMBODIMENTS

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail.

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

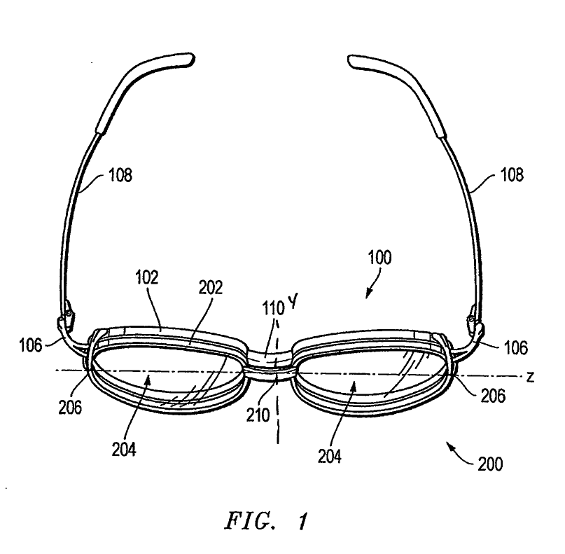

FIG. 1 is an isometric view in accordance with preferred embodiments of the present invention. In this view, a primary lens assembly 100 is coupled to an auxiliary lens assembly 200.

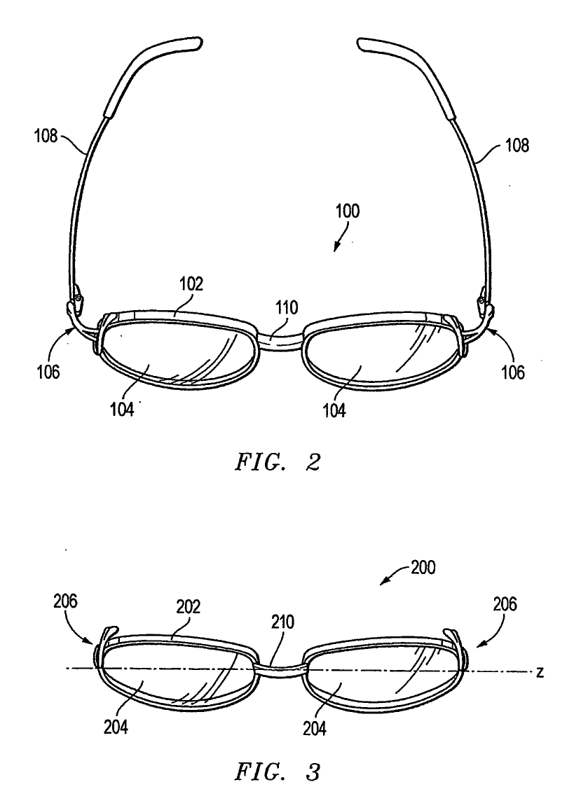

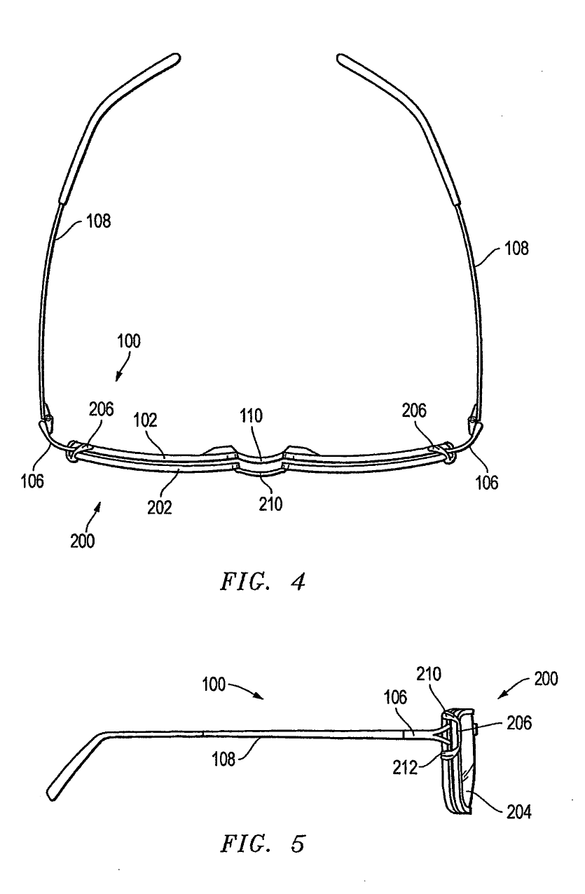

As can be seen in FIGS. 1, 2, 4, 5, and 9, primary lens assembly 100 comprises a primary frame 102, primary lenses 104, primary extensions 106, and arms 108. Primary lenses 104 are secured in fixed positions relative to one another by primary frame 102. Primary extensions 106 are affixed along the outer perimeter of primary frame 102, and arms 108 are rotatably affixed to primary extensions 106.

Primary frame 102 includes a primary bridge 110. Primary bridge 110 is located between primary lenses 104 and is responsible for securing the relative positions of primary lenses 104.

With preferred embodiments depicted in FIGS. 1 and 3-10, auxiliary lens assembly 202 comprises an auxiliary frame 202, auxiliary lenses 204, and auxiliary extensions 206. Auxiliary frame 202 secures auxiliary lenses in fixed positions relative to one another. When auxiliary lens assembly 200 is coupled to primary lens assembly 100, auxiliary lens 204 are in substantial alignment with primary lenses 104. Auxiliary extensions 206 are affixed to the outer perimeter of auxiliary frame 202.

Auxiliary frame 202 comprises an auxiliary bridge 210. Auxiliary bridge 210 is located between auxiliary lenses 204 and is responsible for securing auxiliary lenses 204 in fixed positions relative to one another.

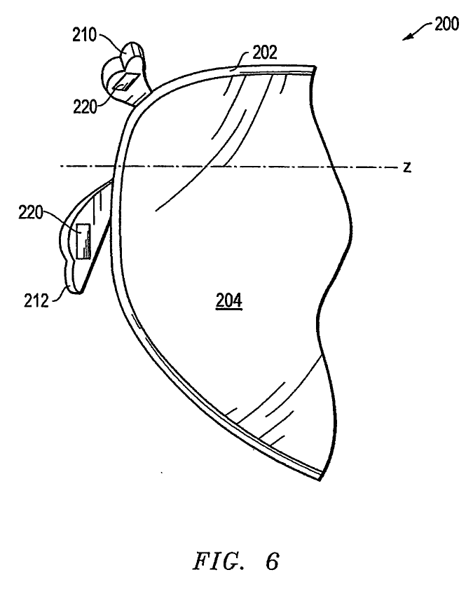

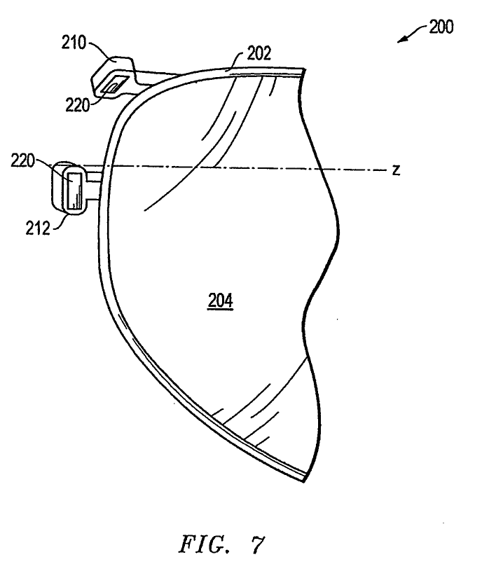

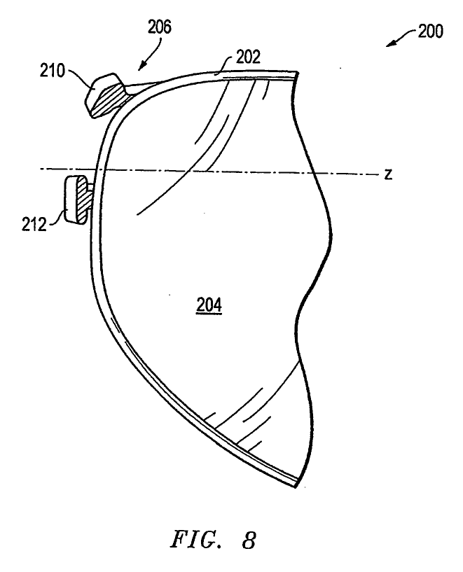

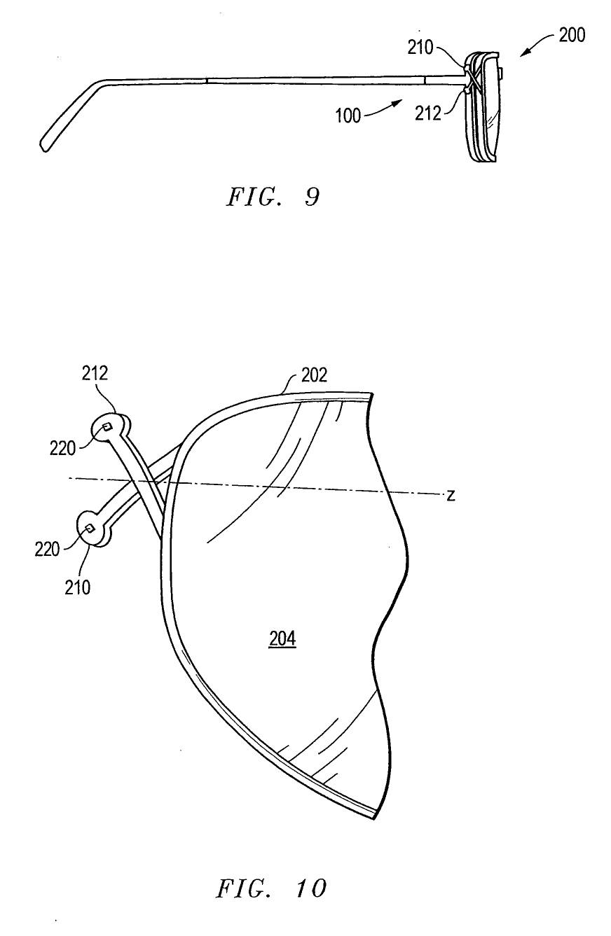

In FIG. 5-10, auxiliary extensions 210 each further comprises an upper section 210 and a lower section 212. In the preferred embodiment of the present invention depicted in FIGS. 5 and 6, upper section 210 and lower section 212 are formed from a single, bifurcated attachment assemblies 206. In an alternate preferred embodiment of the present invention depicted in FIGS. 7 and 8, upper section 210 and lower section 212 are formed from individual arms. In another alternative embodiment of the present invention as depicted in FIGS. 9 and 10, upper section 210 and lower section 212 are formed from individual arms but cross one another.

Additionally, in FIGS. 6, 7, and 10, micromagnets 220 are embedded in upper section 210 and lower section 212 so that auxiliary lens assembly 200 is capable of magnetically coupling to primary frame 100. However, it is also possible to employ an interference fit with primary frame 102 instead of a magnetic coupling as can be seen with FIG. 8.

### Operation Of The Preferred Embodiments

The various embodiments disclosed herein which include magnetic attraction will be appreciated by one of ordinary skill in the art to involve a combination of magnet-to-magnet magnetic engagement, or magnet-to-magnetic material magnetic engagement. “Magnetic material” as used herein is defined as materials subject to attraction by magnetic force, or magnetically attractable.

Referring to FIG. 1 through 10 of the drawings, the reference numeral 100 generally designates a primary lens assembly and the reference numeral 200 generally designates an auxiliary lens assembly.

Primary lens assembly 100 is commonly referred to as a pair of glasses. Primary lens assembly 100 includes a pair of primary extensions that extend from the periphery in direction toward the face of the wearer. Arms 108 are coupled to each of primary extensions 106, such that arms 108 rest over the ears of the wearer.

In addition to having arms 108 support primary lens assembly 100, a primary bridge 110 is included that rests over the nose of the wearer. Primary bridge 110 not only provides support for primary frame 100 over the face of the wearer but also secures primary lenses 104 in fixed position relative to one another, generally over the eyes of the wearer while in use.

When desired, auxiliary lens assembly 200 can be coupled to primary lens assembly 100. When coupled, auxiliary lenses 204 are in substantial alignment with primary lenses 104. Alignment of auxiliary lenses 204 is as a result of auxiliary frame 202 that employs an auxiliary bridge 210 to secure auxiliary lenses in fixed positions relative to one another.

The coupling between auxiliary lens assembly 200 and primary lens assembly 100 is due to a magnetic coupling force or an interference fit. Along the periphery of auxiliary frame 202 are auxiliary extensions 206. Each of the auxiliary extensions 206 have an upper portion 210 and a lower portion 212. In a situation where an interference fit is employed, upper portion 210 and lower portion provide a frictional coupling to primary frames 102. Alternately, in a situation where a magnetic coupling is employed, primary frames 102 are comprised of a magnetically attractable material, and upper portion 210 and lower portion 212 have micromagnets 220 embedded therein. Thus, micromagnets 220 magnetically couple to the primary frames 102.

Typically, micromagnets, such as micromagnets 220, are magnets that are not pressed into individual magnets. Instead, micromagnets are magnets that are pressed into blocks that are larger than the final desired size. The larger, pressed magnets are then sectioned to the desired size. Conventional industry specifications for the sizes of such micromagnets that have consistent magnetic properties are 3 mm wide by 1 mm in long by 0.5 mm in thick, where the thickness is in the direction of force.

In a more preferred embodiment, the micromagnets are made of a Rare-Earth 2 Transition Element having a Maximum Energy Product of at least 210 kJ/m³. In a still more preferred embodiment, the micromagnets are made of an alloy comprising between 22 and 29 percent by weight samarium. Other alloys can also be employed, such as those magnets formed of Rare Earth Cobalt 5 alloys, Rare Earth Iron alloys, and International Electrotechnical Commission (IEC) Code Reference R4-1 materials.

The micromagnets thus specified enjoy the benefit or resistance to oxidation without the need for plating. Because of their small size, plating of micromagnets can cause geometric inconsistencies that negatively affect their ability to be located in slots having complementary geometries.

Specifically, resistance to detachment of auxiliary lens assembly 200 from primary lens assembly 100 is not accomplished just by employing multiple contact points. Instead, strategic positioning of contact points enhances the stability of the auxiliary lens assembly. As can be seen in FIGS. 1 and 3, there are two distinct, orthogonal axes defined: horizontal axis (z) and vertical axis (y). Upper potion 210 and lower portion 212 are designed to straddle horizontal axis (z). With respect to straddling horizontal axis (z), it can be sent that horizontal axis (z) extends between the outer perimeters of auxiliary frame 202 where auxiliary extensions 106 are affixed.

As can be seen in FIGS. 5-8, upper portion 210 couples with primary frame 102 above this axis, and lower portion 212 coupled with primary frame 102 below this axis. As can be seen in FIGS. 9 and 10, upper portion 210 couples with primary frame 102 below this axis, and lower portion 212 coupled with primary frame 102 above this axis. By having a portion on each side of auxiliary frame 202 that couples above and below this axis, there are four distinct points that will secure the positioning of auxiliary frame and provide increase resistivity to decoupling when either vertical or horizontal separating forces are applied.

Moreover, each upper portion 210 and each lower portion are symmetrically positions with each other relative to vertical axis (y). The combination of symmetry with respect to these orthogonal axes thus allows for an very stable mechanism for retaining the position of auxiliary lens assembly 200 when coupled to primary lens assembly 212.

Additionally, the usage of the four coupling points allows for increase aesthetic design capacity. As can be seen in FIGS. 5 and 6, upper portion 210 and lower portion 212 can either be as a result of a bifurcated single auxiliary extension 206. This allows for a particular, aesthetically pleasing design. In contrast, as can be seen in FIGS. 7 and 8, upper portion 210 and lower portion 212 are formed from two distinct pieces to form auxiliary extension 206. This additional configuration, thus, allows for an alternative aesthetically pleasing design.

In another alternative embodiment of the present invention as depicted in FIGS. 9 and 10, upper section 210 and lower section 212 are formed from individual arms but cross one another. This distinctive formation utilizes upper section 210 forming a contact point below primary extension 106 while lower section 212 forms a contact point above primary extension 106. This additional configuration, as well, allows for an alternative aesthetically pleasing design.

Therefore, it can be seen that the present invention provides a number of benefits over more conventional designs. Specifically, because auxiliary extensions 206 straddle primary extensions 106, a wearer can easily couple auxiliary lens assembly 200 to primary lens assembly 210 with a single hand. Additionally, because auxiliary extensions 206 employ multiple coupling points, there is a decreased likelihood of decoupling when vertical and/or horizontal separating forces are applied. Moreover, there are a myriad of aesthetically pleasing designs that can be developed to have a greater appeal to wider variety of consumers.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. An eyewear system comprising:
a primary lens assembly comprising:
a primary frame for retaining a pair of primary lenses;
a pair of primary extensions extending horizontally from the primary frame; and,
an arm pivotally attached to each of the primary extensions;
an auxiliary lens assembly comprising:
an auxiliary frame for retaining a pair of auxiliary lenses;
a pair of upper extensions extending horizontally from each side of the auxiliary frame; and,
a pair of lower extensions extending horizontally from opposite sides of the auxiliary frame; and,
wherein the auxiliary frame is attachable to the primary frame by coincident alignment of the upper extensions above the primary extensions, and the lower extensions below the primary extensions.

2. The eyewear system of claim 1 further comprising:
the distance between the primary extensions is greater than the distance between the upper extensions; and,
the distance between the primary extensions is greater than the distance between the lower extensions.

3. The eyewear system of claim 1 further comprising:
each upper extensions is attached to at least one lower extension.

4. The eyewear system of claim 1 further comprising:
the upper extensions and the lower extensions engage the primary frame in an interference fit.

5. The eyewear system of claim 1 further comprising:
the primary frame made of a magnetically attractable material;
an upper magnet located at an end of each upper extension; and,
a lower magnet located at the end of each lower extension.

6. The eyewear system of claim 1 further comprising:
each upper extension being attached to a lower extension.

7. The eyewear system of claim 1 further comprising:
the primary frame having micromagnets attached to it;
an upper magnet located at an end of each upper extension;
a lower magnet located at the end of each lower extension; and
wherein the micromagnets magnetically engage the upper magnets and the lower magnets when the auxiliary frame is attached to the primary frame.

8. An auxiliary lens assembly, comprising:
first and second auxiliary lens;
an auxiliary frame for securing the first and the second auxiliary lenses in a fixed relationship relative to one another;
wherein the auxiliary frame has a first axis extending from a periphery of said
first auxiliary lens to a periphery of said second auxiliary lens;
a first attachment assembly affixed along said periphery of said first auxiliary lens and straddling said first axis; and
a second attachment assembly affixed along said periphery of said second auxiliary lens and straddling said first axis.

9. The eyewear system of claim 7 further comprising:
the upper extensions and the lower extensions engage the primary extensions in an interference fit.

10. The eyewear system of claim 7 further comprising:
the primary frame made of a magnetically attractable material;
an upper magnet located at an end of each upper extension; and,
a lower magnet located at the end of each lower extension.

11. The auxiliary lens assembly of claim 7, wherein said first magnetic attachment assembly further comprises a pair of micromagnets, wherein each micromagnet is substantially symmetrically positioned on either side of said axis relative to one another.

12. The auxiliary lens assembly of claim 7, wherein said auxiliary lens assembly further comprises a second axis that is orthogonal to said first axis, wherein said first and said second magnetic attachment assemblies are substantially symmetrically positioned on either side of said second axis relative to one another.
